(19) United States
(12) Patent Application Publication
(10) Pub. No.: US 2016/0226771 A1
(43) Pub. Date: Aug. 4, 2016

(54) Load Balancing

(71) Applicant: Progress Software Corporation, Bedford, MA (US)

(72) Inventors: Charles Key, Cincinnati, OH (US); Brandon Cannaday, Cincinnati, OH (US)

(21) Appl. No.: 15/011,259

(22) Filed: Jan. 29, 2016

Related U.S. Application Data
(60) Provisional application No. 62/110,353, filed on Jan. 30, 2015.

(51) Int. Cl. H04L 12/803; H04L 29/08

(52) U.S. Cl. CPC H04L 47/125; H04L 67/18

(57) ABSTRACT

The disclosure includes a system and method for load balancing. In one embodiment, the method includes receiving, using one or more processors, traffic for an application via a managed domain name service; determining, using one or more processors, a first load balancer from a plurality of load balancers; and sending the traffic to the first load balancer based on the determination.

### CROSS REFERENCE TO RELATED APPLICATIONS

The present application claims priority, under 35 U.S.C. §119, of U.S.

Provisional Patent Application No. 62/110,353, filed Jan. 30, 2015 and entitled “Load Balancing,” which is incorporated by reference in its entirety.

### FIELD OF INVENTION

The present disclosure relates to connecting to data sources. Specifically, providing connectivity as a service to one or more data sources.

### BACKGROUND

Load balancers may receive traffic (e.g. requests related to application writing) from clients and distribute the traffic across entities that act based on the received traffic (e.g. respond to the requests). A first problem with existing load balancers is that they fail to provide affinity and direct traffic from a particular client to the same entity and thereby create inefficiencies in acting upon the requests and do not generate actionable user intelligence. A second problem with existing load balancers is that they are not geographically distributed and communicatively coupled to one another to reduce lag.

### SUMMARY

The disclosure includes load balancing that addresses one or more of the deficiencies above are disclosed herein. In one embodiment, the method includes receiving, using one or more processors, traffic for an application via a managed domain name service; determining, using one or more processors, a first load balancer from a plurality of load balancers; and sending the traffic to the first load balancer based on the determination.

Other implementations of one or more of these aspects include corresponding systems, apparatus, and computer programs, configured to perform the actions of the methods, encoded on computer storage devices. These and other implementations may each optionally include one or more of the following features.

In some embodiments, the method further includes determining one or more locations of application instances of the application; determining which a first application instance was most recently reached by prior traffic of a requester associated with the received traffic; and wherein the traffic is sent to the first application instance associated with the first load balancer based on the first application instance being most recently reached by earlier traffic of the requester. In some embodiment, the method further includes ordering the one or more locations of application instances based on how recently the location of the application instance was reached by prior traffic of a requester associated with the traffic.

In some embodiments, the plurality of load balancers includes the first load balancer and a second load balancer, the traffic is received by a second load balancer prior to being sent to the first load balancer, and the first load balancer is determined based on geographic proximity to the second load balancer. In some embodiments, the traffic is sent from the second load balancer to the first load balancer using a connection of one or more infrastructure providers associated with one or more of the first load balancer and the second load balancer rather than via an Internet service provider. In some embodiments, the second load balancer is not associated with an instance of the application. In some embodiments, the first load balancer and the second load balancer are associated with a different infrastructure providers.

In some embodiments, the plurality of load balancers includes the first load balancer and a second load balancer, wherein the traffic is received by a second load balancer prior to being sent to the first load balancer, and the first load balancer is determined based a latency associated with the first load balancer being less than a latency associated with one or more of the second load balancer a third load balancer included in the plurality of load balancers. In some embodiments, at least one of the first load balancer, the second load balancer and the third load balancer is associated with a different infrastructure provider. In some embodiments, the second load balancer is not associated with an instance of the application and wherein the latency associated with the first load balancer is less than a latency associated with the third load balancer, the first load balancer associated with an instance of the application and the third load balancer associated with an instance of the application.

It should be understood that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a diagram illustrating an example of host devices and application instances according to one embodiment.

FIG. 2 is a diagram illustrating an example of a load balancer and host according to one embodiment.

FIG. 3 is a diagram illustrating an example of a load balancer and a host in failover according to one embodiment.

FIG. 4 is a diagram illustrating an example of a load balancer and host providing affinity according to one embodiment.

FIG. 5 is a diagram illustrating an example of a geographically distributed load balancer and host environment according to one embodiment.

FIG. 6 is a diagram illustrating an example of traffic handling with inter-load balancer communication according to one embodiment.

FIG. 7 is a diagram illustrating an example of traffic handling without inter-load balancer communication according to one embodiment.

FIG. 8 is a block diagram of an example of a load balancer according to one embodiment.

FIG. 9 is a block diagram of an example of a load balancing service according to one embodiment.

FIG. 10 is flowchart of an example method for reducing lag time using inter-load balancer communication according to one embodiment.

FIG. 11 is a flowchart of an example method for load balancing to provide affinity according to one embodiment.

### DETAILED DESCRIPTION

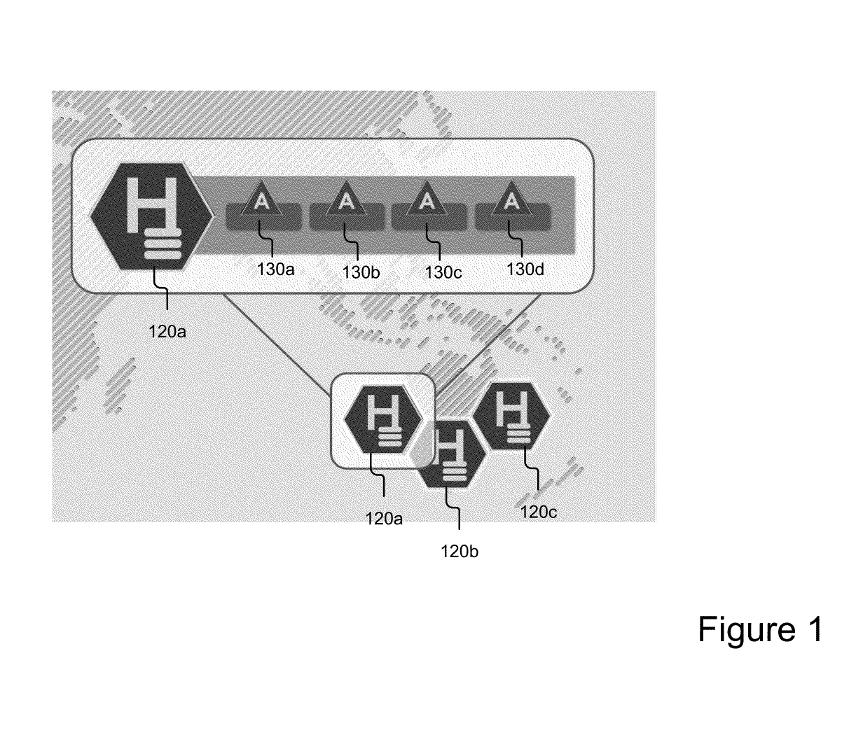

FIG. 1 is a diagram illustrating an example of hosts 120a-c and application instances 130a-d according to one embodiment. While FIG. 1 illustrates three hosts 120a, 120b and 120c (also referred to individually as host 120 and collectively as hosts 120), it should be recognized that the disclosure herein applies to a system including one or more hosts 120. It should also be recognized that although FIG. 1 illustrates four application instances 130a, 130b, 130c and 130d (also referred to individually as application instance 130 and collectively as application instances 130), it should be recognized that the disclosure herein applies to a system including one or more application instances 130.

In one embodiment, a host 120 includes a plurality of mini-servers occasionally referred to herein as “servos.” In one embodiment, each servo is a separate physical device. In another embodiment, each servo may be a separate virtual device. In one embodiment, each servo of the host 120 may run an instance of an application 130. For example, each servo runs an application instance 130 of a web application. In one embodiment, the host 120 scales the number of servos and application instances based on capacity. For example, when one or more of the servos running application instances 130a-d utilize a threshold amount of their associated available resources; in one embodiment, another servo may initiate an additional application instance (not shown). In one embodiment, the application instances 130 utilize Node.js

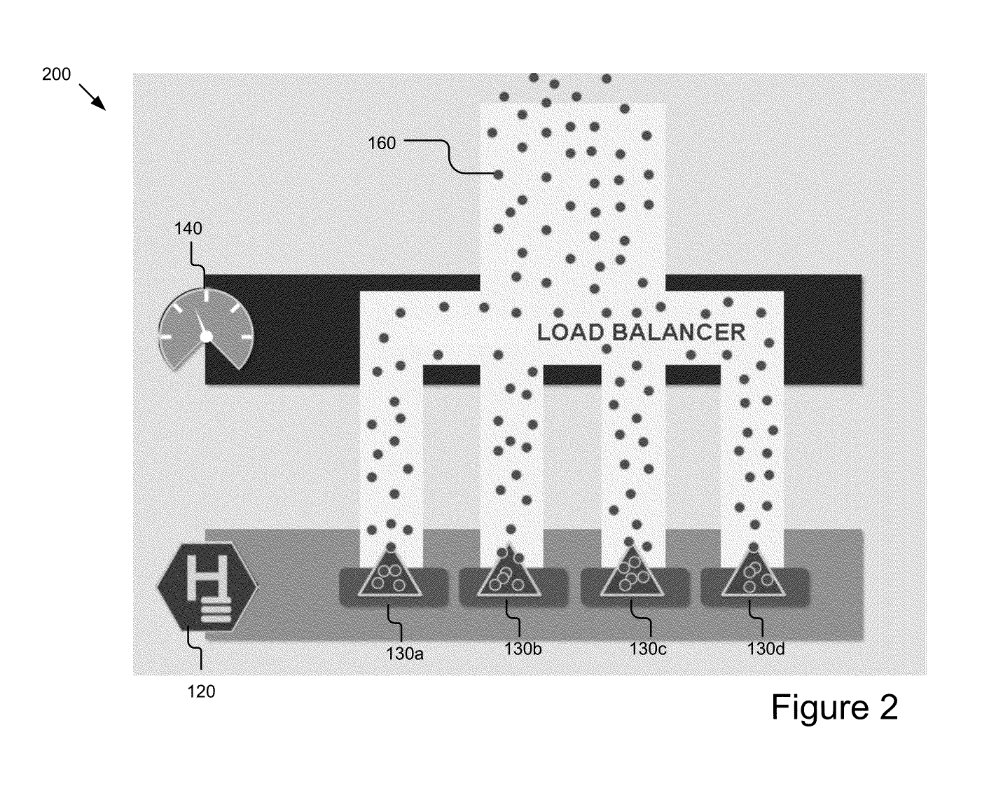

FIG. 2 is a diagram illustrating an example of a load balancer and host according to one embodiment. In one embodiment, a host 120 is associated with a load balancer 140. In one embodiment, the load balancer 140 distributes traffic represented by dots such as dot 160 among multiple application instances 130. For example, the load balancer 140 distributes traffic evenly across all instances of the application 130.

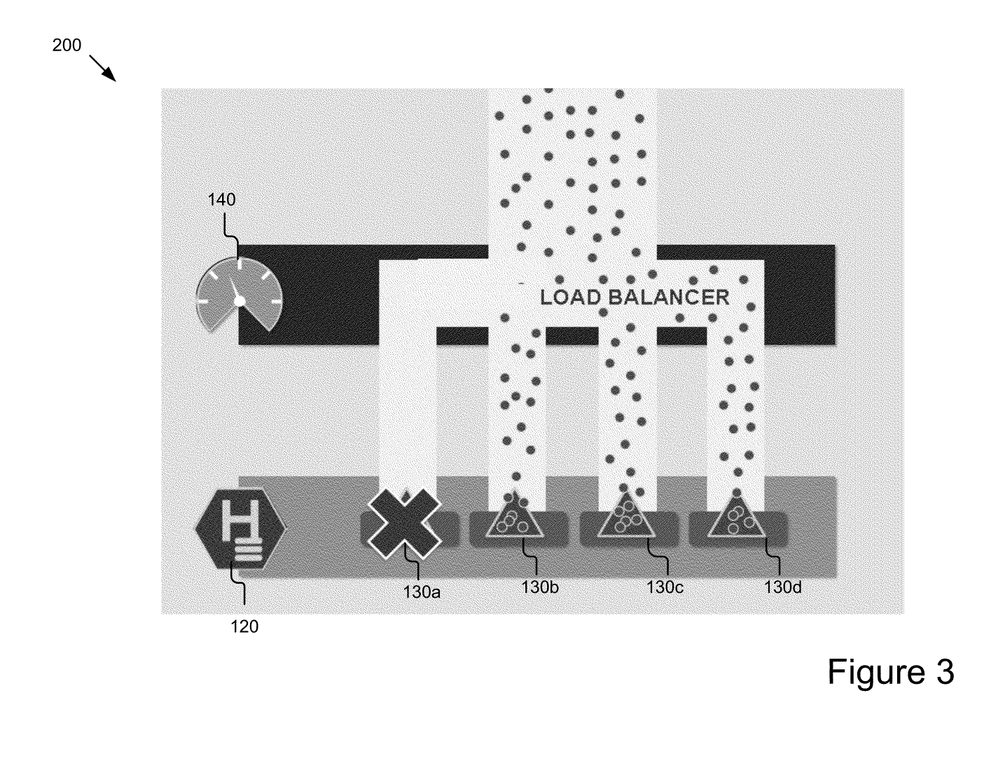

FIG. 3 is a diagram illustrating an example of a load balancer and host in failover according to one embodiment. In the illustrated embodiment, application instance 130a has become unavailable (e.g. the servo running that instance has failed), and the load balancer 140 migrates the traffic 160 that was directed to application instance 130a among the application instances still available 130b-d. In one embodiment, the load balancer 140 migrates the traffic 120 to functioning servos running application instances 130 without down time.

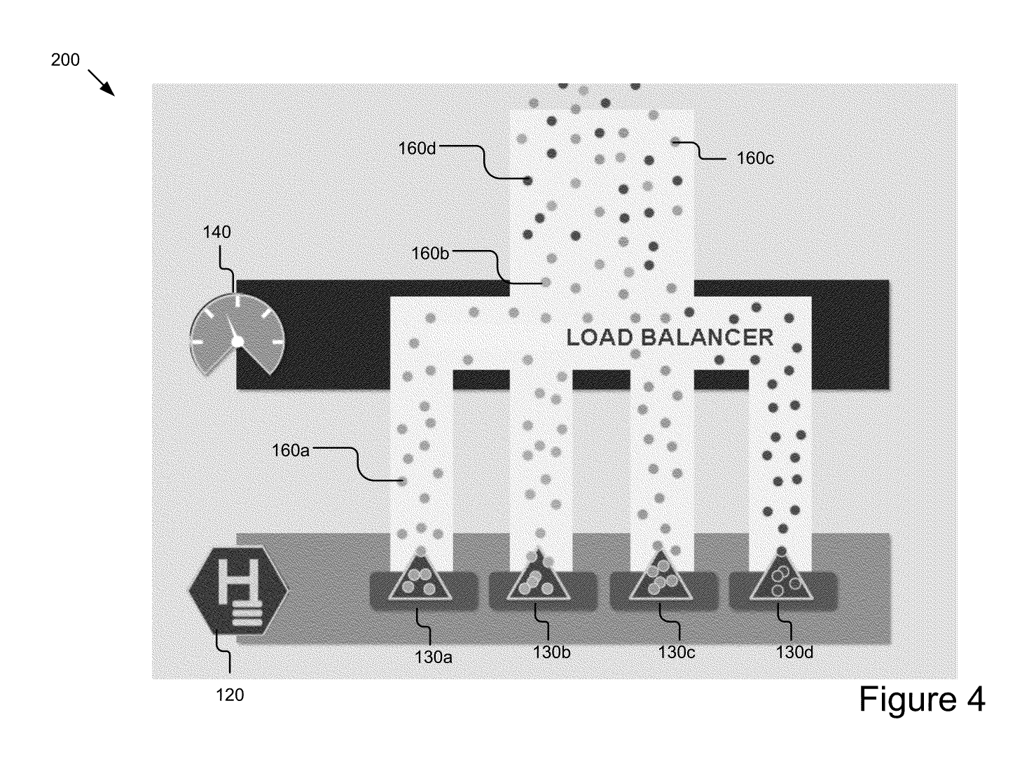

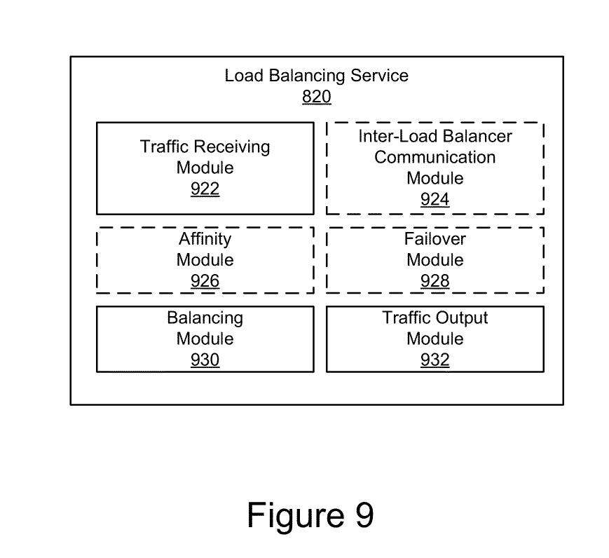

FIG. 4 is a diagram illustrating an example of a load balancer and host providing affinity according to one embodiment. In one embodiment, the load balancer 140 provides affinity by directing traffic from a specific client to the same servo and application instance 130. Providing affinity may beneficially simplify application writing and facilitate actionable user intelligence. In the illustrated embodiment, the traffic 160 has four shades/colors 160a-d in order to represent traffic from four different clients and traffic 160a is directed to application instance 130a, traffic 160b is directed to application instance 160b, traffic 160c is directed to application instance 160c and traffic 160d is directed to application instance 160d. It should be recognized that the number of clients was selected as an example. In one embodiment, any number of clients may provide traffic that is distributed by the load balancer 140 providing affinity and there is not necessarily a one-to-one ratio between clients and servos/application instances 130. Affinity is discussed further with respect to FIG. 9 below.

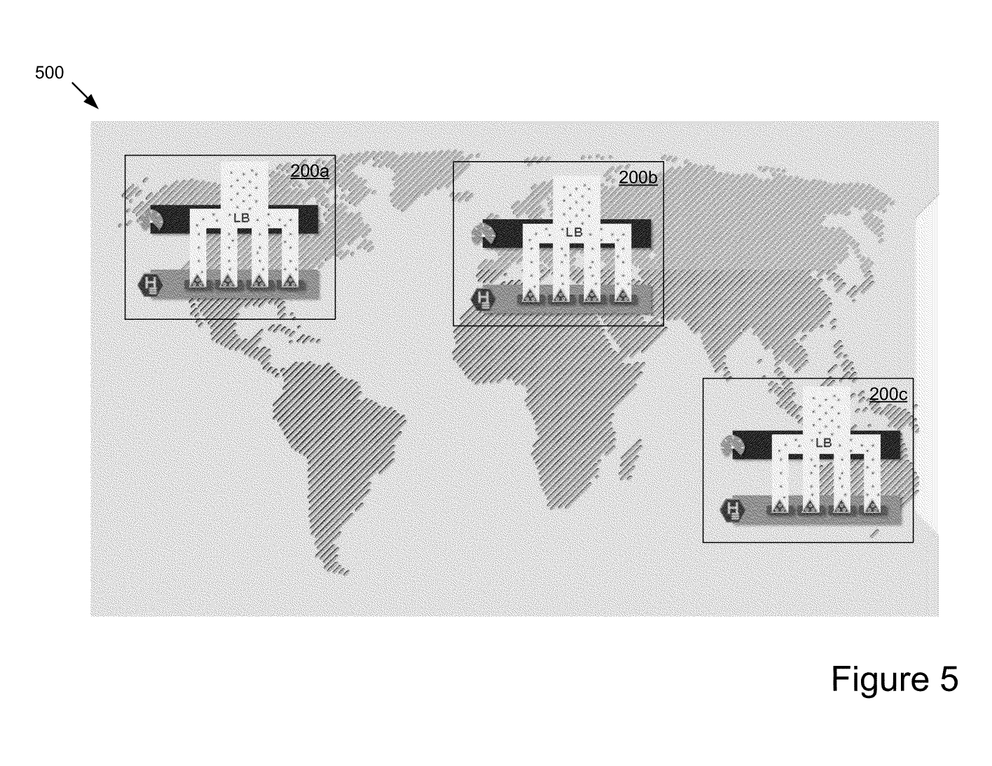

FIG. 5 is a diagram illustrating an example of a geographically distributed load balancer and host environment 500 according to one embodiment. FIG. 5 illustrates three load balancers and associated host pairs 200a-c. In the illustrated embodiment, load balancer and associated host pair 200a is located in North America, load balancer and associated host pair 200b is located in Europe and load balancer and associated host pair 200c is located in Australia. However, it should be recognized that these locations are merely examples and a different number of load balancer and associated host pairs may be located in different locations. In one embodiment, the geographically distributed load balancer and host environment 500 includes a managed domain name system (DNS) and the managed DNS routes traffic from a specific region to the nearest load balancer 140.

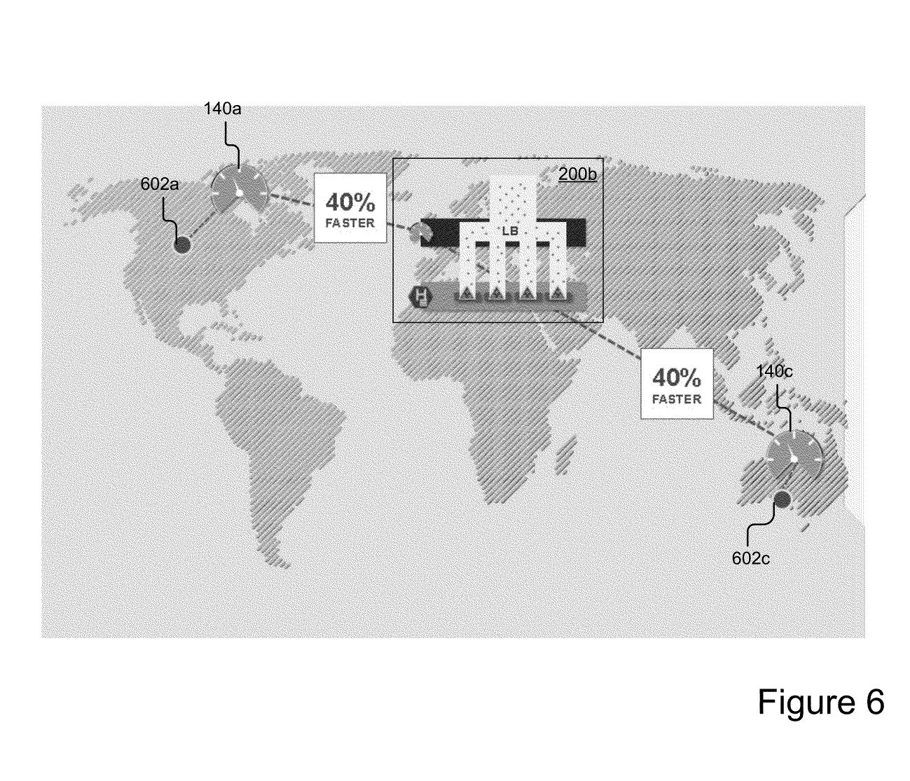

In one embodiment, the load balancers 140 in the geographically distributed load balancer and host environment 500 communicate with one another. In one embodiment, each load balancer 140 in the geographically distributed load balancer and host environment 500 maintains a record of which load balancer is associated with which servos and application instances. In one embodiment, the managed DNS routes traffic from clients in a specific region to the nearest load balancer 140 and that load balancer 140 determines whether it or another load balancer 140 is associated with the host of the application. FIG. 6 is a diagram illustrating an example of traffic handling with inter-load balancer communication according to one embodiment. In the illustrated embodiment, in which traffic from a client 602a in N. America is routed to the nearest load balancer 140a (e.g. by a managed DNS) which determines that the requested application instance(s) are associated with a load balancer 140b and host 120b in Europe and routes the traffic to the load balancer 140b in Europe. Similarly, traffic from a client 602c in Australia is routed to the nearest load balancer 140c (e.g. by a managed DNS) which determines that the requested application instances are associated with a load balancer 140b and host 120b in Europe and routes the traffic to the load balancer 140b in Europe.

In one embodiment, the traffic from the client 602a in N. America is routed by the load balancer 140a in N. America to the load balancer 140b and host 120b in Europe in order to maintain affinity (e.g. previous traffic from the client 602a in N. America was routed to the load balancer 140b and host 120b in Europe). In one embodiment, the traffic from the client 602a in N. America is routed by the load balancer 140a in N. America to the load balancer 140b and host 120b in Europe because the load balancer 140b and host 120b in Europe are the “best available.” In one embodiment, best available refers to one or more of closest geographic location (e.g. the closest load balancer associated with an application instance) and lowest latency (e.g. the load balancer with the lowest latency). For example, assume that load balancer 140b and host 120b are in Europe and load balancer 140c and host 120c are in Australia. Also, assume that the application instances 130 are associated with a host 120b in Europe and host 120c in Australia, but the host 120a in N. America does not have an application instance running or its application instances are under heavy load. In one embodiment, traffic from the client 602a in N. America is routed is routed by the load balancer 140a in N. America to the load balancer 140b in Europe because the load balancer 140b in Europe provides less latency than the load balancer 140a in N. America and less latency than the load balancer 140c in Australia. In one embodiment, traffic from the client 602a in N. America is routed is routed by the load balancer 140a in N. America to the load balancer 140b in Europe because the load balancer 140b in Europe is geographically closer to the load balancer 140a in N. America than the load balancer 140c in Australia.

In one embodiment, the “best available” inter-load balancer communication is implemented via DNS. For example, in one embodiment, latency-based routing is done via service such as Dyn and geographic routing is done via a service such as Amazon Route 53. In one embodiment, “best available” is user configurable. For example, a user may determine whether to use geographic location or latency as the basis for inter-load balancer communication of traffic. In one embodiment, a default is established (e.g. latency-based) which may be modified (e.g. changed to closest geographic location) by a user.

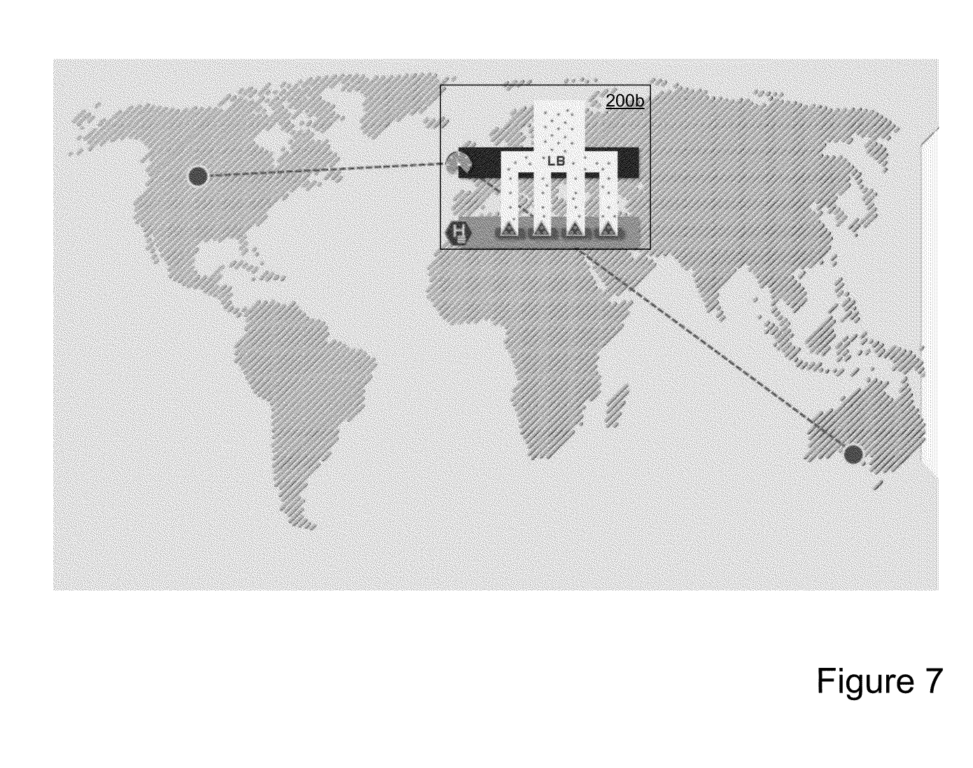

By optimizing requests at the DNS level, the inter-communication of load balancers is able to leverage the infrastructure of hardware providers (e.g. Amazon Web Services (AWS), Joyent, etc.) which have substantial backend connections in place to move traffic quickly and reduces the amount of lag experienced by clients and is an improvement over systems that rely on relatively slow internet service provider (ISP) connections. In one embodiment, the inter-communicating load balancers disclosed herein may provide a 40% faster connection than relying on ISP connections (without inter-communicating load balancers) as shown in FIG. 7, which is a diagram illustrating an example of traffic handling without inter-load balancer communication according to one embodiment.

In one embodiment, once the traffic lands at the load balancer (e.g. load balancer 140b in Europe) a lookup is performed to determine the locations of the endpoint). In one embodiment, this look up utilizes data in a database accessible to all load balancers. In one embodiment, the endpoint is a combination of an IP address and a port—the access point for a servo connection. In one embodiment, a Transmission Control Protocol (TCP) connection is established with the servo associated with obtained IP address and port. If the servo is available and responding (i.e. the TCP connection succeeds), the traffic is sent to the servo.

In one embodiment, the inter-load balancer communication routes traffic regardless of the originating location. For example, the a user in Europe requesting an application hosted in North America will, most likely, be routed to a European load balancer 140b which routes the request to the North American load balancer 140a via the provider's enhanced connection. In one embodiment, the inter-load balancer communication may occur when the regions are within different infrastructure providers (e.g. the European load balancer 140b operates on AWS hardware and the N, American load balancer 14a operates on Joyent hardware).

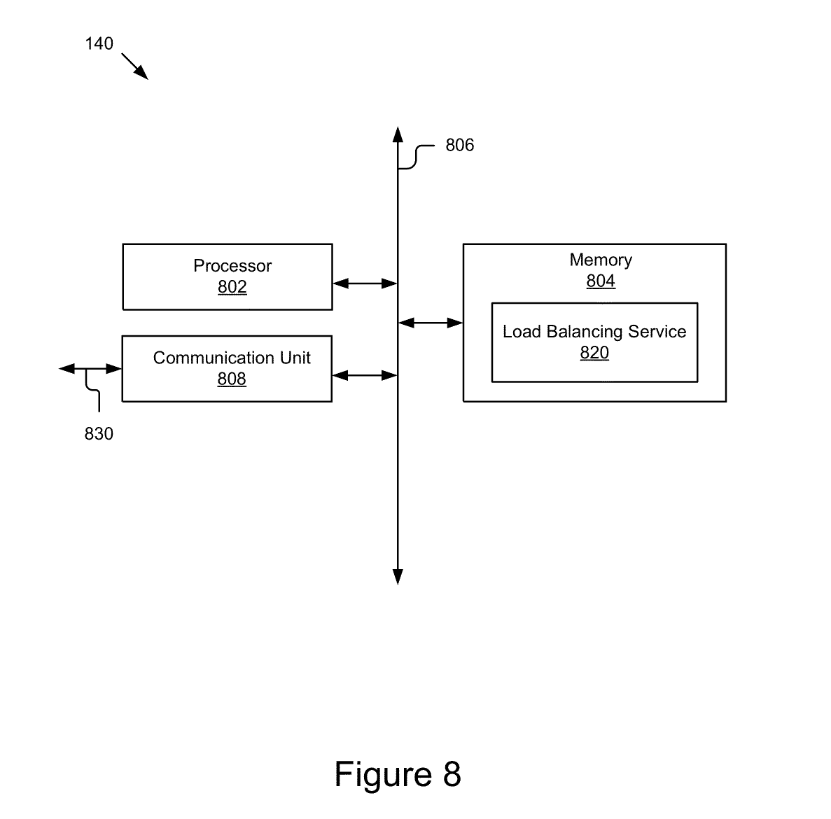

FIG. 8 is a block diagram of an example load balancer 140 according to one embodiment. The load balancer 140, as illustrated, may include a processor 802, a memory 804 and a communication unit 808, which may be communicatively coupled by a communications bus 806. The load balancer 140 depicted in FIG. 8 is provided by way of example and it should be understood that it may take other forms and include additional or fewer components without departing from the scope of the present disclosure. For example, while not shown, the load balancer 140 may include a storage device, input and output devices (e.g., a display, a keyboard, a mouse, touch screen, speakers, etc.), various operating systems, sensors, additional processors, and other physical configurations.

The processor 802 may execute code, routines and software instructions by performing various input/output, logical, and/or mathematical operations. The processor 802 have various computing architectures to process data signals including, for example, a complex instruction set computer (CISC) architecture, a reduced instruction set computer (RISC) architecture, and/or an architecture implementing a combination of instruction sets. The processor 802 may be physical and/or virtual, and may include a single core or plurality of processing units and/or cores. In some implementations, the processor 802 may be capable of generating and providing electronic display signals to a display device (not shown), supporting the display of images, capturing and transmitting images, performing complex tasks including various types of feature extraction and sampling, etc. In some implementations, the processor 802 may be coupled to the memory 804 via the bus 806 to access data and instructions therefrom and store data therein. The bus 806 may couple the processor 802 to the other components of the load balancer 140 including, for example, the memory 804 and communication unit 808.

The memory 804 may store and provide access to data to the other components of the load balancer 140. In some implementations, the memory 804 may store instructions and/or data that may be executed by the processor 802. For example, in the illustrated embodiment, the memory 804 may store the load balancing 820. The memory 804 is also capable of storing other instructions and data, including, for example, an operating system, hardware drivers, other software applications, databases, etc. The memory 804 may be coupled to the bus 806 for communication with the processor 802 and the other components of the load balancer 140.

The memory 804 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 802. In some embodiments, the memory 804 may include one or more of volatile memory and non-volatile memory. For example, the memory 804 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blu-ray™, etc.). It should be understood that the memory 804 may be a single device or may include multiple types of devices and configurations.

The bus 806 can include a communication bus for transferring data between components of a load balancer 140 and/or between computing devices (e.g. between the load balancer 140 and one or more client devices (not shown) and host devices 120), a network bus system including the network 102 or portions thereof, a processor mesh, a combination thereof, etc. In some implementations, the load balancer 140, its sub-components and various other software operating on the load balancer 140 (e.g., an operating system, etc.) may cooperate and communicate via a software communication mechanism implemented in association with the bus 806. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 808 may include one or more interface devices (I/F) for wired and/or wireless connectivity with the network 102. For instance, the communication unit 808 may include, but is not limited to, CAT-type interfaces; wireless transceivers for sending and receiving signals using radio transceivers (4G, 3G, 2G, etc.) for communication with the mobile network 102, and radio transceivers for Wi-Fi™ and close-proximity (e.g., Bluetooth®, NFC, etc.) connectivity, etc.; USB interfaces; various combinations thereof; etc. In some implementations, the communication unit 808 can link the processor 802 to the network (not shown), which may in turn be coupled to other processing systems. The communication unit 808 can provide other connections to the network (not shown) and to other entities of the system (e.g. client devices (not shown and hosts 120) using various standard network communication protocols.

As mentioned above, the load balancer 140 may include other and/or fewer components. Examples of other components may include a display, an input device, a sensor, etc. (not shown). In one embodiment, the load balancer 140 includes a display. The display may display electronic images and data for presentation to a user. The display may include any conventional display device, monitor or screen, including, for example, an organic light-emitting diode (OLED) display, a liquid crystal display (LCD), etc. In some implementations, the display may be a touch-screen display capable of receiving input from a stylus, one or more fingers of a user, etc. For example, the display may be a capacitive touch-screen display capable of detecting and interpreting multiple points of contact with the display surface.

The input device (not shown) may include any device for inputting information into the connectivity server 122. In some implementations, the input device may include one or more peripheral devices. For example, the input device may include a keyboard (e.g., a QWERTY keyboard or keyboard in any other language), a pointing device (e.g., a mouse or touchpad), microphone, an image/video capture device (e.g., camera), etc. In some implementations, the input device may include a touch-screen display capable of receiving input from the one or more fingers of the user. For example, the user could interact with an emulated (i.e., virtual or soft) keyboard displayed on the touch-screen display by using fingers to contacting the display in the keyboard regions.

### Example Load Balancing Service 820 Module

Referring now to FIG. 9, the load balancing service 820 module is shown in more detail according to one embodiment. FIG. 9 is a block diagram of the load balancing service 820 module included in a load balancer 140 according to one embodiment.

The load balancing service 820 module provides the features and functionality discussed herein. For example, in one embodiment, the load balancing service 820 provides affinity while distributing traffic. In another example, the load balancing service 820 module provides inter-load balancer communication, as described above, to enhance connectivity. In one embodiment, the load balancing service is Server Name Indication (SNI) Secure Socket Layer (SSL) capable and traffic may be received from endpoints and/or distributed using secure (e.g. HTTPS) connections.

In some embodiments, the load balancing service 220 module includes a traffic receiving module 922, an optional inter-load balancer communication module 924, an optional affinity module 926, an optional failover module 928, a balancing module 930 and a traffic output module 932.

In some embodiments one or more of the modules are a set of instructions executable by the processor 802. In some embodiments, one or more of the modules are stored in the memory 804 and are accessible and executable by the processor 802. In either embodiment, modules are adapted for cooperation and communication with the processor 802, other components of the load balancer 140, other components and other components of the system described in FIG. 1-7 (e.g. client devices and hosts 120). In one embodiment, one or more of the modules are written using an expressive, concurrent, garbage collected programming language (e.g. Google Go).

The traffic receiving module 922 receives traffic. For example, traffic for an instance of a web application 130. The traffic receiving module 922, depending on the embodiment, passes traffic to one or more of the other modules of the load balancing service 820 or stores the received traffic for retrieval by one or more of the other modules of the load balancing service 820.

In one embodiment, the load balancing service includes an inter-load balancer communication module 924. In one embodiment, the inter-load balancer communication module 924 determines whether the local load balancer (i.e. the load balancer that received the traffic) is associated with the host of the application instance associated with the traffic. When the inter-load balancer communication module 924, determines that the local load balancer is not associated with the host of an application instance associated with the traffic, the inter-load balancer communication module 924 determines a load balancer that is and direct the traffic to the determined load balancer. In one embodiment, the inter-load balancer communication module 924 determines (e.g. based on geographic location or latency) which load balancer is the best available load balancer associated with a host of an application instance associated with the traffic and the traffic is directed to that best available load balancer. In one embodiment, when the inter-load balancer communication module 924, determines that the local load balancer is associated with the host of an application instance associated with the traffic, the balancing module 930 determines to which application instance 130 of the host associated with the receiving load balancer to direct the traffic to and the traffic output module 934 sends the traffic to the determined application instance. In one embodiment, when the inter-load balancer communication module 924, determines that the local load balancer is associated with the host of an application instance associated with the traffic, the balancing module 930 determines whether there is a better available load balancer associated with a host of an application instance associated with the traffic and directs the traffic to the traffic output module 934 which sends the traffic to the determined load balancer having better availability (e.g. lower latency).

In one embodiment, the load balancing service 820 includes an affinity module 926. In one embodiment, the affinity module 926 determines whether affinity is enabled for the load balancer 140 and/or application instances 130. In one embodiment, affinity is enabled by default. In one embodiment, affinity is configured via an environmental variable passed into the load balancer 140 upon initializing the load balancer 140 (e.g. when starting the load balancer 140). When affinity is enabled, the balancing module 930 distributes traffic in a manner that provides affinity, which is discussed further below with reference to the balancing module 930.

The failover module 928 detects unavailability of an application instance and/or the servo(s) associated with that application instance and informs the balancing module of the failure. In one embodiment, the balancing module 930 immediately migrates traffic to other application instances 130 and servos providing no interruption or down time to the user and the user's access to the application.

The balancing module 930 determines how to distribute traffic to various application instances of the associated host 120. As mentioned above, in some embodiments, the balancing module distributes traffic in order to provide affinity and/or migrates data responsive to a failover condition.

In one embodiment, the balancing module 830 tracks endpoints. For example, in one embodiment, possible locations of thousands of hostnames may be received. For example, myapp.example.com has ten instances of their application running so when a request (i.e. traffic) comes in (received by the load balancer) it could be routed to any of those ten instances. That's one endpoint tracked. In one embodiment, the load balancer 140 is made to handle thousands of these endpoints using a database (not shown). In one embodiment, the database used to track endpoints is a NoSQL database such as a key-value store (e.g. Redis).

In one embodiment, the balancing module 930 provides affinity by determining a requesting IP address, storing (e.g. in a cache) the requesting IP address, building and maintaining a queue of possible application locations (when multiple application instances 130 are running) with the last location reached at the top of the list. In one embodiment, the other locations are arranged randomly in the remainder of the list. It should be recognized that this may result in overweighting one location over others. However, affinity may beneficially provide easier application writing and actionable user intelligence. It should be noted that while the above description utilizes a queue the disclosure herein contemplates that other data structures (e.g. a stack) may be used with some modification and that use of other data structures is within the scope of this disclosure.

The traffic output module 932 outputs (e.g. sends) the traffic to the application instance 130/servo determined by the balancing module 932.

For clarity and convenience, the present disclosure did not provide extensive details regarding certain components of the system mentioned with regard to FIGS. 1-9 and some components are not shown in FIGS. 1-9. For example, a managed DNS, a network and a client device may not be illustrated or discussed in detail above.

A managed DNS (not shown) may include one or more computing devices having data processing, storing, and communication capabilities according to one embodiment. For example, the managed DNS (not shown) may include one or more hardware servers, server arrays, storage devices, systems, etc., and/or may be centralized or distributed/cloud-based. In some implementations, the managed DNS (not shown) may include one or more virtual servers, which operate in a host server environment and access the physical hardware of the host server including, for example, a processor, memory, storage, network interfaces, etc., via an abstraction layer (e.g., a virtual machine manager).

The network (not shown) may include any number of networks and/or network types. For example, the network may include, but is not limited to, one or more local area networks (LANs), wide area networks (WANs) (e.g., the Internet), virtual private networks (VPNs), mobile networks (e.g., the cellular network), wireless wide area network (WWANs), Wi-Fi networks, WiMAX® networks, Bluetooth® communication networks, peer-to-peer networks, other interconnected data paths across which multiple devices may communicate, various combinations thereof, etc. Data transmitted by the network may include packetized data (e.g., Internet Protocol (IP) data packets) that is routed to designated computing devices coupled to the network 102. In some implementations, the network may include a combination of wired and wireless (e.g., terrestrial or satellite-based transceivers) networking software and/or hardware that interconnects the computing devices of the system 200. For example, the network may include packet-switching devices that route the data packets to the various computing devices based on information included in a header of the data packets.

The data exchanged over the network can be represented using technologies and/or formats including the hypertext markup language (HTML), the extensible markup language (XML), JavaScript Object Notation (JSON), Binary JavaScript Object Notation, Comma Separated Values (CSV), etc. In addition, all or some of links can be encrypted using conventional encryption technologies, for example, the secure sockets layer (SSL), Secure Hypertext Transfer Protocol (HTTPS) and/or virtual private networks (VPNs) or Internet Protocol security (IPsec). In another embodiment, the entities can use custom and/or dedicated data communications technologies instead of, or in addition to, the ones described above. Depending upon the embodiment, the network can also include links to other networks.

In one embodiment, components of the system described with reference to FIGS. 1-8 are communicatively coupled via a network. For example, the various load balancers 140 are coupled by a network and inter-load balancer communication is carried by the network. In another example, the traffic received by the load balancer 140 is network traffic and the network carries traffic (e.g. requests) from a client device to the load balancer.

The client device 106 is a computing device having data processing and communication capabilities. In some embodiments, a client device 106 may include a processor (e.g., virtual, physical, etc.), a memory, a power source, a network interface, and may include other components whether software or hardware, such as a display, graphics processor, wireless transceivers, input devices (e.g. mouse, keyboard, camera, sensors, etc.) firmware, operating systems, drivers, various physical connection interfaces (e.g., USB, HDMI, etc.). The client devices 106 may couple to and communicate with one another and the other entities (e.g. load balancer 140, managed DNS, etc.) via the network using a wireless and/or wired connection.

Examples of client devices may include, but are not limited to, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. The system described herein may include any number of client devices. In addition, the any number of client devices may be the same or different types of computing devices.

### Example Methods

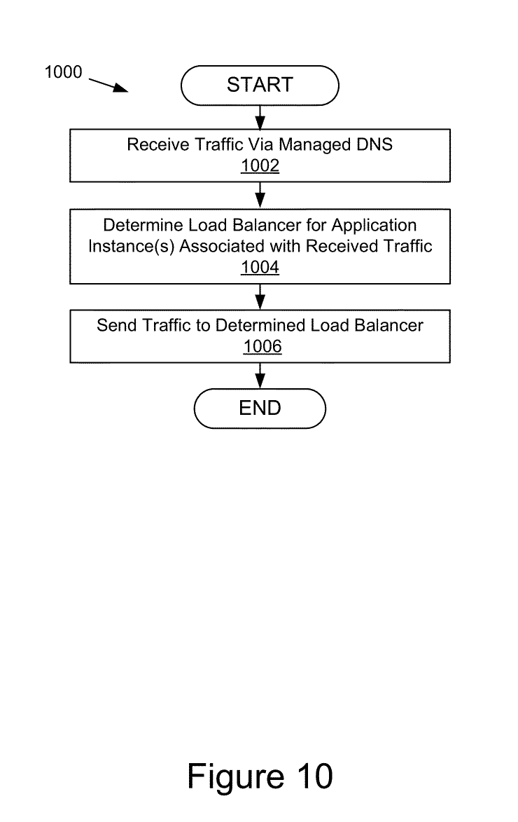

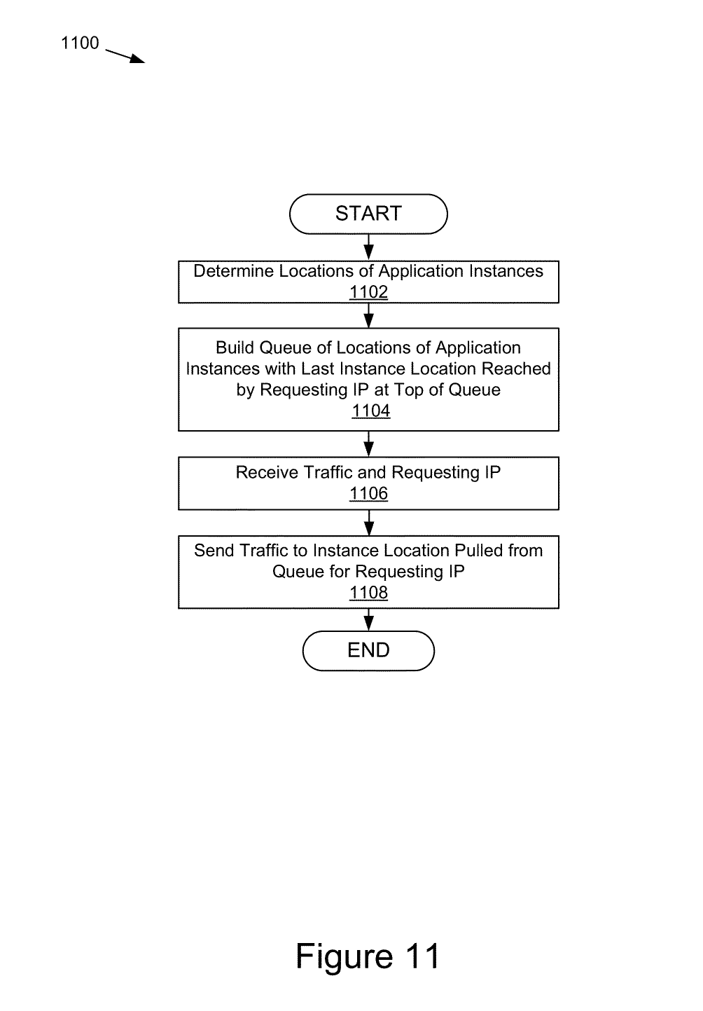

FIGS. 10 and 11 depict methods 1000 and 1100 performed by the system described above in reference to FIGS. 1-9 according to one embodiment. FIG. 10 is flowchart of an example method for reducing lag time using inter-load balancer communication according to one embodiment. The method 1000 begins at block 1002. At block 1002, the traffic receiving module 922 receives traffic from a managed DNS. At block 1004, the inter-load balancer communication module 924 determines the load balancer for one or more application instances associated with the traffic received at block 1002. At block 1006, the inter-load balancer communication module 924 sends the traffic to the load balancer determined at step 1004, when the determined load balancer is another load balancer and the method 1000 ends.

FIG. 11 is a flowchart of an example method 1100 for load balancing to provide affinity according to one embodiment. While the below description indicates that the blocks are performed by the balancing module 930, it should be recognized that the blocks may be performed by other modules (e.g. the affinity module 926) in cooperation with or instead of the balancing module 930. At block 1102, the balancing module 930 determines locations of application instances. At block 1104, the balancing module 930 builds a queue of locations of application instances with the last application instance's location reached by the requesting IP at the top of the queue. At block 1106, the balancing module 930 receives traffic from the requesting IP and, at block 1108, sends the traffic to the location of an application instance pulled from the queue associated with the requesting IP via the traffic output module 932 and the method 1100.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc.

Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
receiving, using one or more processors, traffic for an application via a managed domain name service;
determining, using one or more processors, a first load balancer from a plurality of load balancers; and
sending the traffic to the first load balancer based on the determination.

2. A method of claim 1 comprising:
determining one or more locations of application instances of the application;
determining which a first application instance was most recently reached by prior traffic of a requester associated with the received traffic; and
wherein the traffic is sent to the first application instance associated with the first load balancer based on the first application instance being most recently reached by earlier traffic of the requester.

3. A method of claim 2 comprising:
ordering the one or more locations of application instances based on how recently the location of the application instance was reached by prior traffic of a requester associated with the traffic.

4. The method of claim 1, wherein the plurality of load balancers includes the first load balancer and a second load balancer, wherein the traffic is received by a second load balancer prior to being sent to the first load balancer and the first load balancer is determined based on geographic proximity to the second load balancer.

5. The method of claim 4, wherein the traffic is sent from the second load balancer to the first load balancer using a connection of one or more infrastructure providers associated with one or more of the first load balancer and the second load balancer rather than via an Internet service provider.

6. The method of claim 4, wherein the second load balancer is not associated with an instance of the application.

7. The method of claim 4, wherein the first load balancer and the second load balancer are associated with a different infrastructure providers.

8. The method of claim 1, wherein the plurality of load balancers includes the first load balancer and a second load balancer, wherein the traffic is received by a second load balancer prior to being sent to the first load balancer, and the first load balancer is determined based a latency associated with the first load balancer being less than a latency associated with one or more of the second load balancer a third load balancer included in the plurality of load balancers.

9. The method of claim 8, wherein at least one of the first load balancer, the second load balancer and the third load balancer is associated with a different infrastructure provider.

10. The method of claim 8, wherein the second load balancer is not associated with an instance of the application and wherein the latency associated with the first load balancer is less than a latency associated with the third load balancer, the first load balancer associated with an instance of the application and the third load balancer associated with an instance of the application.

11. A system comprising:
one or more processors; and
a memory storing instructions that, when executed by the one or more processors, cause the system to:
receive traffic for an application via a managed domain name service;
determine a first load balancer from a plurality of load balancers; and
send the traffic to the first load balancer based on the determination.

12. The system of claim 11, further comprising instructions that, when executed by the one or more processors, cause the system to:
determining one or more locations of application instances of the application;
determining which a first application instance was most recently reached by prior traffic of a requester associated with the received traffic; and
wherein the traffic is sent to the first application instance associated with the first load balancer based on the first application instance being most recently reached by earlier traffic of the requester.

13. The system of claim 11, wherein the plurality of load balancers includes the first load balancer and a second load balancer, wherein the traffic is received by a second load balancer prior to being sent to the first load balancer and the first load balancer is determined based on geographic proximity to the second load balancer.

14. The system of claim 14, wherein the traffic is sent from the second load balancer to the first load balancer using a connection of one or more infrastructure providers associated with one or more of the first load balancer and the second load balancer rather than via an Internet service provider.

15. The system of claim 14, wherein the second load balancer is not associated with an instance of the application.

16. The system of claim 14, wherein the first load balancer and the second load balancer are associated with a different infrastructure providers.

17. The system of claim 11, wherein the plurality of load balancers includes the first load balancer and a second load balancer, wherein the traffic is received by a second load balancer prior to being sent to the first load balancer, and the first load balancer is determined based a latency associated with the first load balancer being less than a latency associated with one or more of the second load balancer a third load balancer included in the plurality of load balancers.

18. The system of claim 17, wherein at least one of the first load balancer, the second load balancer and the third load balancer is associated with a different infrastructure provider.

19. The system of claim 17, wherein the second load balancer is not associated with an instance of the application and wherein the latency associated with the first load balancer is less than a latency associated with the third load balancer, the first load balancer associated with an instance of the application and the third load balancer associated with an instance of the application.

20. A non-transitory computer readable medium having instructions stored thereon, wherein the instructions, when executed by a processor, cause the processor to:
receive traffic for an application via a managed domain name service;
determine a first load balancer from a plurality of load balancers; and
send the traffic to the first load balancer based on the determination.
